(19) United States
(12) Patent Application Publication
(10) Pub. No.: US 2016/0270141 A1
(43) Pub. Date: Sep. 15, 2016

(54) WIRELESS NETWORK CONNECTION SETUP USING MULTIPLE RADIO ACCESS TECHNOLOGIES

(71) Applicant: QUALCOMM Incorporated, San Diego, CA (US)

(72) Inventors: Manu SHARMA, San Diego, CA (US); Jangwon LEE, San Diego, CA (US); Rajat PRAKASH, San Diego, CA (US); Kalle Ilmari AHMAVAARA, San Diego, CA (US); Andrei Dragos RADULESCU, San Diego, CA (US)

(21) Appl. No.: 14/811,211

(22) Filed: Jul. 28, 2015

Related U.S. Application Data
(60) Provisional application No. 62/132,388, filed on Mar. 12, 2015.

(51) Int. Cl. H04W 76/02

(52) U.S. Cl. CPC H04W 76/026; H04W 88/06

(57) ABSTRACT

A method of wireless communication includes establishing, by a mobile device, an access connection to a first mobile network for network connectivity of the mobile device to the first mobile network. The mobile device includes a first transceiver of a first radio access technology (RAT) type and a second transceiver of a second RAT type, where establishing the access connection comprises performing a plurality of connection setup procedures. At least one of the connection setup procedures is communicated with the first transceiver over the first RAT type and at least another one of the connection setup procedures is communicated with the second transceiver over the second RAT type.

### CROSS-REFERENCE TO RELATED APPLICATION

The present application for patent claims the benefit of U.S. Provisional Application No. 62/132,388, entitled “WIRELESS NETWORK CONNECTION SETUP USING MULTIPLE RADIO ACCESS TECHNOLOGIES,” filed Mar. 12, 2015, assigned to the assignee hereof, and expressly incorporated herein by reference in its entirety.

### FIELD OF DISCLOSURE

This disclosure relates generally to mobile communications and, in particular but not exclusively, relates to a wireless connection setup of a mobile device on a mobile network.

### BACKGROUND

Wireless communication systems are widely deployed to provide various types of communication content such as, voice, data, and so on. Typical wireless communication systems may be multiple-access systems capable of supporting communication with multiple users by sharing available system resources (e.g., bandwidth, transmission power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long-term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations.

To supplement conventional base stations, additional low-power base stations can be deployed to provide more robust wireless coverage to mobile devices. For example, low-power base stations, which can be commonly referred to as Home NodeBs or Home eNBs, collectively referred to as H(e)NBs, femto nodes, femtocell nodes, pico nodes, micro nodes, etc., can be deployed for incremental capacity growth, richer user experience, in-building or other specific geographic coverage, and/or the like. By way of example, a Neutral Host LTE Network (NH-LTE network) is an LTE-based wireless network that provides internet connectivity service to devices within its coverage area. The NH-LTE network may include one or more LTE small low-power cells (referred to as NH Access Points) and is particularly targeted for non-mobile network operators (non-MVOs) (e.g., businesses, sporting venues, shopping malls, airports, etc.). However, these low-power base stations are often deployed and operated separately of other NH-LTE networks and of any MNO networks.

### SUMMARY

Aspects of the present disclosure include a method, an apparatus, a mobile device, an access point, and non-transitory computer-readable medium for establishing an access connection of a device to a network using two or more RATs.

In one aspect, a method of wireless communication includes establishing, by a mobile device, an access connection to a first mobile network for network connectivity of the mobile device to the first mobile network. The mobile device includes a first transceiver of a first radio access technology (RAT) type and a second transceiver of a second RAT type, where establishing the access connection comprises performing a plurality of connection setup procedures. At least one of the connection setup procedures is communicated with the first transceiver over the first RAT type and at least another one of the connection setup procedures is communicated with the second transceiver over the second RAT type.

In another aspect, a method of wireless communication includes establishing, by one or more access points of a first mobile network, an access connection to a mobile device for network connectivity of the mobile device to the first mobile network. The one or more access points of the first mobile network include a first transceiver of a first radio access technology (RAT) type and a second transceiver of a second RAT type, where establishing the access connection comprises performing a plurality of connection setup procedures. At least one of the connection setup procedures is communicated with the first transceiver over the first RAT type and at least another one of the connection setup procedures is communicated with the second transceiver over the second RAT type.

In yet another aspect, a mobile device is provided that includes a first transceiver of a first radio access technology (RAT) type, a second transceiver of a second RAT type, memory adapted to store program code, and a processing unit coupled to the memory to access and execute instructions included in the program code. The instructions are configured to direct the mobile device to establish an access connection to a first mobile network for network connectivity of the mobile device to the first mobile network. The instructions to establish the access connection comprise instructions to perform a plurality of connection setup procedures, where at least one of the connection setup procedures is communicated with the first transceiver over the first RAT type and at least another one of the connection setup procedures is communicated with the second transceiver over the second RAT type.

In still another aspect, an access point is provided that includes a first transceiver of a first radio access technology (RAT) type, a second transceiver of a second RAT type, memory adapted to store program code, and a processing unit coupled to the memory to access and execute instructions included in the program code. The instructions are configured to direct the access point to establish an access connection to a mobile device for network connectivity of the mobile device to the first mobile network by the access point. The instructions to establish the access connection comprises instructions to perform a plurality of connection setup procedures, where at least one of the connection setup procedures is communicated with the first transceiver over the first RAT type and at least another one of the connection setup procedures is communicated with the second transceiver over the second RAT type.

In another aspect, a mobile device is provided that includes a first transceiver of a first radio access technology (RAT) type, a second transceiver of a second RAT type, and means for establishing an access connection to a first mobile network for network connectivity of the mobile device to the first mobile network. The means for establishing the access connection comprises means for performing a plurality of connection setup procedures, where at least one of the connection setup procedures is communicated with the first transceiver over the first RAT type and at least another one of the connection setup procedures is communicated with the second transceiver over the second RAT type.

In yet another aspect, an access point is provided that includes a first transceiver of a first radio access technology (RAT) type, a second transceiver of a second RAT type, and means for establishing an access connection with a mobile device for network connectivity of the mobile device to the first mobile network. The means for establishing the access connection comprises means for performing a plurality of connection setup procedures, where at least one of the connection setup procedures is communicated with the first transceiver over the first RAT type and at least another one of the connection setup procedures is communicated with the second transceiver over the second RAT type.

According to another aspect, a non-transitory computer-readable medium includes program code stored thereon for wireless communication. The program code includes instructions to direct a mobile device to establish an access connection to a first mobile network for network connectivity of the mobile device to the first mobile network. The instructions to establish the access connection comprises instructions to perform a plurality of connection setup procedures, where at least one of the connection setup procedures is communicated with a first transceiver, of the mobile device, over the first RAT type and at least another one of the connection setup procedures is communicated with a second transceiver, of the mobile device, over the second RAT type.

In one aspect, a non-transitory computer-readable medium includes program code stored thereon for wireless communication. The program code includes instructions to direct one or more access points of a first mobile network to establish an access connection with a mobile device for network connectivity of the mobile device to the first mobile network by the access point. The instructions to establish the access connection comprises instructions to perform a plurality of connection setup procedures, where at least one of the connection setup procedures is communicated with a first transceiver, of the one or more access points, over the first RAT type and at least another one of the connection setup procedures is communicated with a second transceiver, of the one or more access points, over the second RAT type.

In another aspect, a method of wireless communication includes establishing, by a mobile device, an access connection to a first mobile network for network connectivity of the mobile device to the first mobile network. The mobile device includes a first Long-Term Evolution (LTE) wireless communication transceiver and a second LTE wireless communication transceiver, where establishing the access connection includes performing a plurality of connection setup procedures, where at least one of the connection setup procedures is communicated with the first transceiver over LTE and at least another one of the connection setup procedures is communicated with the second transceiver over LTE.

In yet another aspect, a mobile device is provided that includes a first Long-Term Evolution (LTE) wireless communication transceiver, a second LTE wireless communication transceiver, memory adapted to store program code, and a processing unit coupled to the memory to access and execute instructions included in the program code. The instructions are configured to direct the mobile device to establish an access connection to a first mobile network for network connectivity of the mobile device to the first mobile network, where the instructions to establish the access connection includes instructions to perform a plurality of connection setup procedures. At least one of the connection setup procedures is communicated with the first transceiver over LTE and at least another one of the connection setup procedures is communicated with the second transceiver over LTE.

In another aspect, a mobile device is provided that includes a first Long-Term Evolution (LTE) wireless communication transceiver, a second LTE wireless communication transceiver, and means for establishing an access connection to a first mobile network for network connectivity of the mobile device to the first mobile network. The means for means for establishing the access connection includes means for performing a plurality of connection setup procedures, where at least one of the connection setup procedures is communicated with the first transceiver over LTE and at least another one of the connection setup procedures is communicated with the second transceiver over LTE.

According to another aspect, a non-transitory computer-readable medium includes program code stored thereon for wireless communication. The program code includes instructions to direct a mobile device to establish an access connection to a first mobile network for network connectivity of the mobile device to a first mobile network. The instructions to establish the access connection include instructions to perform a plurality of connection setup procedures, where at least one of the connection setup procedures is communicated with a first Long-Term Evolution (LTE) wireless communication transceiver of the mobile device over LTE and at least another one of the connection setup procedures is communicated with a second LTE wireless communication transceiver of the mobile device over LTE.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communication system including macro cell base stations and small cell base stations.

FIG. 2 illustrates an example wireless communication system including an Access Point (AP) in communication with a mobile device.

FIG. 3A is a flowchart illustrating a process, performed by a mobile device, of wireless communication that includes establishing an access connection to a mobile network.

FIG. 3B is a flowchart illustrating a process, performed by one or more access points of a mobile network, of wireless communication that includes establishing an access connection of a mobile device to the mobile network.

FIG. 4 is a flowchart illustrating a process of communicating connection setup parameters with a first mobile network while simultaneously communicating with a base station of a second mobile network.

FIG. 5 is a flowchart illustrating a process of wireless communication that includes establishing an access connection of a mobile device to a first mobile network where network discovery, authentication, and data traffic procedures are performed over a first Radio Access Technology (RAT) type, while credential provisioning and policy provisioning procedures are performed over a second RAT type.

FIG. 6 is a flowchart illustrating a process of wireless communication that includes establishing an access connection of a mobile device to a first mobile network where network discovery, credential provisioning, and policy provisioning procedures are performed over a second RAT type, while authentication and data traffic procedures are performed over a first RAT type.

FIG. 7 is a flowchart illustrating a process of wireless communication that includes establishing an access connection of a mobile device to a first mobile network where network discovery, authentication, policy provisioning, and data traffic procedures are performed over a first RAT type, while credential provisioning procedures are performed over a second RAT type.

FIG. 8 is a flowchart illustrating a process of wireless communication that includes establishing an access connection of a mobile device to a first mobile network where network discovery procedures are performed over a first RAT type, while credential provisioning, policy provisioning, authentication, and data traffic procedures are performed over a second RAT type.

FIG. 9 is a simplified block diagram illustrating several sample aspects of components that may be employed in an access point apparatus configured to support communication as taught herein.

FIG. 10 is a simplified block diagram illustrating several sample aspects of components that may be employed in a mobile device apparatus configured to support communication as taught herein.

FIG. 11 is an example call flow procedure to establish an access connection of a mobile device to a first mobile network.

### DETAILED DESCRIPTION

More specific aspects of the disclosure are provided in the following description and related drawings directed to various examples provided for illustration purposes. Alternate aspects may be devised without departing from the scope of the disclosure. Additionally, well-known aspects of the disclosure may not be described in detail or may be omitted so as not to obscure more relevant details.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., Application Specific Integrated Circuits (ASICs)), by program instructions being executed by one or more processors, or by a combination of both. In addition, for each of the aspects described herein, the corresponding form of any such aspect may be implemented as, for example, “logic configured to” perform the described action.

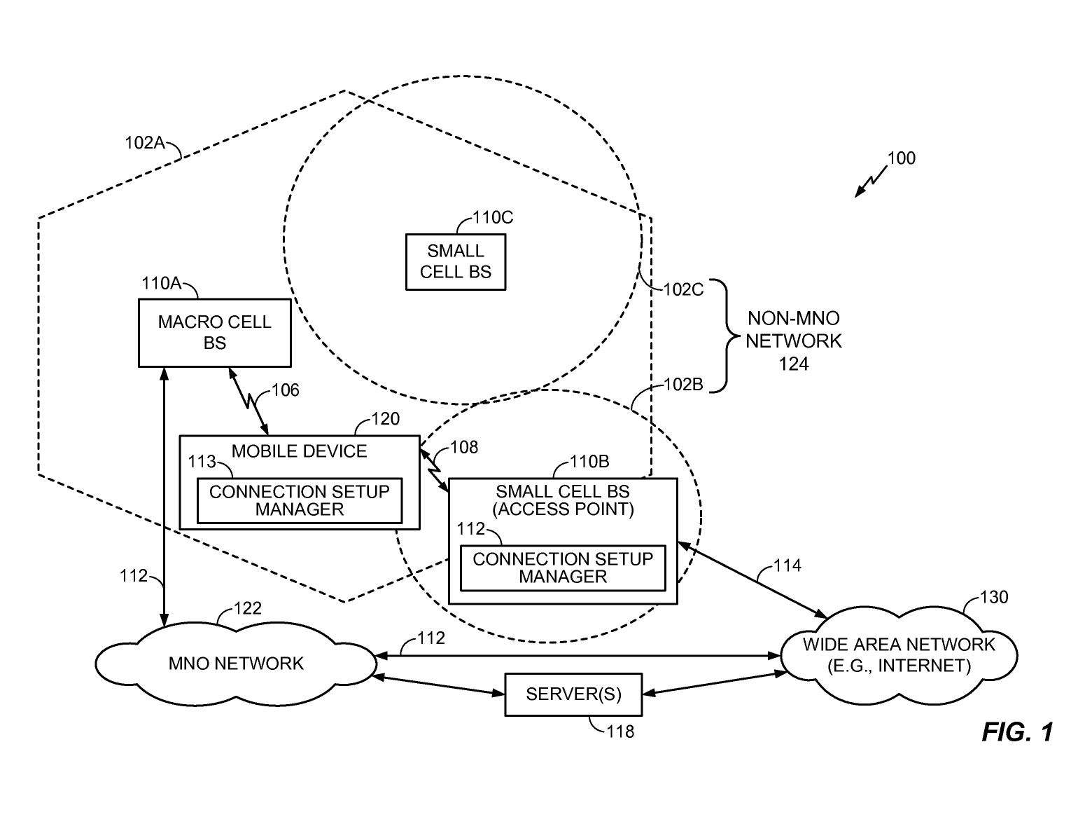

FIG. 1 illustrates an example wireless communication 100, in which small cell base stations (110B and 110C) are deployed to supplement the coverage of macro cell base station (110A). As used herein, small cells generally refer to a class of low-powered base stations that may include or be otherwise referred to as femto cells, pico cells, micro cells, etc. As noted above, the small low-power base stations may be deployed by a non-Mobile Network Operator (MNO) to extend or otherwise improve access to a mobile network (e.g., MNO network 122). In the illustrated example of FIG. 1, a first mobile network (e.g., non-MNO network 124) includes the small cell base stations (access points) 110B and 110C, while macro cell base station 110A may be included in a second mobile network (e.g., MNO network 122). In one embodiment, the non-MNO network 124 includes a Neutral Host LTE network (NH-LTE network).

An NH-LTE network may be an LTE-based wireless network that provides internet connectivity service to devices within its coverage area and is designed to lower the cost of LTE access by allowing scalable self-contained network deployments that can serve devices from multiple service providers. An NH-LTE network may be deployed within a venue, enterprise, in a neighborhood, vehicle, home, small-medium business or in any other premises, where each NH-LTE network is typically deployed and operated separately of other NH-LTE networks and of any mobile networks, e.g. it could be operated by IT staff of the enterprise. The NH-LTE network is adapted to operate in typical Wi-Fi deployment models, while providing the same quality of service (QoS), mobility, and security as regular LTE (e.g., macro base stations provided by a mobile network operator (MNO)).

In one example, an NH-LTE network includes self-contained radio access and core network functions. The NH-LTE network's core network implementation may be a scaled-down version that can be deployed to support the specific NH-LTE network deployment. The NH-LTE network's core may be located on-site, in a suitable transport aggregation point, at individual eNB, and/or in the cloud.

An NH-LTE network typically allows devices to connect to it based on authentication, authorization, and/or accounting procedures via a local or remote AAA/HSS server. The NH-LTE network may support EAP authentication which allows clients and AAA to use a variety of mechanisms, such as EAP-AKA′, EAP-TLS or EAP-TTLS. The NH-LTE network may also support features allowing users to sign up for service by interacting with a service portal.

In some examples, NH-LTE Networks support technology that allow deployment with limited integration, tuning and configuration effort, e.g. relying on Self Organizing Network (SON) features. The NH-LTE network may be based on LTE or and LTE in Unlicensed (LTE-U) radio technologies and may also support Wi-Fi and other radio technologies.

The NH-LTE network includes one or more LTE small low-power cells (referred to as NH Access Points), such as small cell base stations 110B and 110C, and may be targeted for non-MNOs (e.g., businesses, sporting venues, shopping malls, airports, etc.). In some configurations, such low-power base stations (e.g., NH Access Points) are connected to a wide area network 130 via broadband connection (e.g., digital subscriber line (DSL) router, cable or other modem, etc.), which can provide the backhaul link to the MNO network 122.

However, low-power base stations are often deployed without consideration of a specific MNO and may provide a backhaul link to several separate and distinct MNOs. Thus, before accessing MNO network 122 by way of the NH-LTE backhaul link, a mobile device 120 may be required to authenticate.

The process of network capability discovery and credential/subscription provisioning on a conventional NH-LTE Network takes time as the user of the mobile device 120 may be required to provide identifying and/or payment information. Furthermore, for mobile devices 120 with a single LTE radio, mobile terminated calls may be missed and/or data applications disrupted, as the mobile device 120 with a single LTE radio may be required to disconnect from the macro cell base station 110A during discovery and authentication on the NH-LTE Network. To establish a data communication link with the NH-LTE Network the mobile device 120 might need to perform a number of connection setup steps including capability discovery and credential/subscription provisioning. If the mobile device 120 is connected to another LTE Network (e.g., via macro cell base station 110A) and the mobile device 120 has a single LTE capable radio transceiver, then the mobile device 120 will need to tune away from the macro cell base station 110A to perform connection setup on the NH-LTE network. This will create disruptions to services (e.g., internet service) running on the mobile device 120 which may be not be restored until the mobile device 120 has successfully established an access connection (e.g., data communication link) with the NH-LTE Network.

Accordingly, aspects of the present disclosure include a method, an apparatus, a mobile device, an access point, and non-transitory computer-readable medium for establishing an access connection of a mobile device to a network using two or more radio access technologies (RATs). As will be described in more detail below, using two or more RATs in establishing an access connection to a mobile network may allow the mobile device to maintain an existing link (e.g., to a macro cell base station) while performing the connection setup steps with another network, such as an NH-LTE network. As an alternate way of solving the problem, the mobile device may perform some steps of establishing the access connection to the NH-LTE network using the existing link (e.g., to a macro cell base station).

Returning now to FIG. 1, the illustrated wireless communication system 100 is a multiple-access system that is divided into a plurality of cells 102A-C and configured to support communication for a number of mobile devices 120. Communication coverage in each of the cells 102A-C is provided by a corresponding base station 110A-C, which interacts with one or more mobile devices 120 via DownLink (DL) and/or UpLink (UL) connections. In general, the DL corresponds to communication from a base station to a mobile device, while the UL corresponds to communication from a user device to a base station.

The mobile device 120 and one or more of the small cell base stations 110B, 110C may be configured in accordance with the teachings herein to provide or otherwise support the establishment of an access connection of the mobile device 120 to a first mobile network (e.g., non-MNO network 124) by communicating connection setup procedures with the non-MNO network 124. In one example, the establishment of an access connection is to establish a data communication link between the mobile device 120 and the non-MNO network 124 for network connectivity of the mobile device 120 on the non-MNO network 124. Thus, once the access connection is established, one or more applications running on the mobile device 120 may immediately begin using the non-MNO network 124. To facilitate the establishment of an access connection, one or more of the small cell base stations 110B, 110C may include a connection setup manager 112, while one or more of the mobile devices 120 may include a connection setup manager 113 to aide in or otherwise perform connection setup procedures over multiple radio access technology (RAT) types.

As used herein, the terms “mobile device” and “base station” are not intended to be specific or otherwise limited to any particular Radio Access Technology (RAT), unless otherwise noted. In general, such mobile devices, such as mobile device 120, may be any wireless communication device (e.g., a mobile phone, router, personal computer, server, etc.) used by a user to communicate over a communications network, and may be alternatively referred to in different RAT environments as an Access Terminal (AT), a Mobile Station (MS), a Subscriber Station (STA), a User Equipment (UE), etc. Similarly, a base station may operate according to one of several RATs in communication with user devices depending on the network in which it is deployed, and may be alternatively referred to as an Access Point (AP), a Network Node, a NodeB, an evolved NodeB (eNB), etc. In addition, in some systems a base station may provide purely edge node signaling functions while in other systems it may provide additional control and/or network management functions.

Returning to FIG. 1, the different base stations 110A-C include an example macro cell base station 110A and two example small cell base stations 110B, 110C. The macro cell base station 110A is configured to provide communication coverage within a macro cell coverage area (e.g., cell 102A), which may cover a few blocks within a neighborhood or several square miles in a rural environment. Meanwhile, the small cell base stations 110B, 110C are configured to provide communication coverage within respective small cell coverage areas 102B, 102C, with varying degrees of overlap existing among the different coverage areas. In some systems, each cell may be further divided into one or more sectors (not shown).

Turning to the illustrated connections in more detail, the mobile device 120 may transmit and receive messages via a wireless link 106 with the macro cell base station 110A, the messages including information related to various types of communication (e.g., voice, data, multimedia services, associated control signaling, etc.). The mobile device 120 may similarly communicate with the small cell base station 110B via another wireless link 108, and the mobile device 120 may similarly communicate with the small cell base station 110C via another wireless link (not shown).

As is further illustrated in FIG. 1, the macro cell base station 110A may communicate with the corresponding wide area network 130, via a wired link or via a wireless link 107, while the small cell base stations 110B, 110C may also similarly communicate with the wide area network 130, via their own wired or wireless links 114. For example, the small cell base stations 110B, 110C may communicate with the wide area network 130 by way of an Internet Protocol (IP) connection, such as via a Digital Subscriber Line (DSL, e.g., including Asymmetric DSL (ADSL), High Data Rate DSL (HDSL), Very High Speed DSL (VDSL), etc.), a TV cable carrying IP traffic, a Broadband over Power Line (BPL) connection, an Optical Fiber (OF) cable, a satellite link, or some other link.

The wide area network 130 may comprise any type of electronically connected group of computers and/or devices, including, for example, Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the wide area network 130 includes network variations such as the public Internet, a private network within the Internet, a secure network within the Internet, a private network, a public network, a value-added network, an intranet, and the like. In certain systems, the wide area network 130 may also comprise a Virtual Private Network (VPN).

Accordingly, it will be appreciated that the macro cell base station 110A and/or either or both of the small cell base stations 110B, 110C may be connected to the wide area network 130 using any of a multitude of devices or methods. These connections may be referred to as the “backbone” or the “backhaul” of the wide area network 130, and may in some implementations be used to manage and coordinate communications between the macro cell base station 110A, the small cell base station 110B, and/or the small cell base station 110C. In this way, as the mobile device 120 moves through such a mixed communication network environment that provides both macro cell and small cell coverage, the mobile device 120 may be served in certain locations by the macro cell base station 110A, at other locations by small cell base stations 110B and/or 110C, and, in some scenarios, by both macro cell base station 110A and small cell base station 110B and 110C.

For their wireless air interfaces, each base station 110A-C may operate according to one of several RATs depending on the network in which it is deployed. These networks may include, for example, Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. The terms “network” and “system” are often used interchangeably. A CDMA network may implement a RAT such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a RAT such as Global System for Mobile Communications (GSM). An OFDMA network may implement a RAT such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS, and LTE are described in documents from an organization named “3rd Generation Partnership Project” (3GPP). cdma2000 is described in documents from an organization named “3rd Generation Partnership Project 2” (3GPP2).

In LTE networks, a subscriber identity module (SIM) card provided by a mobile network operator may be used to authenticate a mobile device to a network. For neutral host networks NH-LTE network, there may be a need to allow any mobile device to connect and securely authenticate to any NH-LTE network without a SIM card. An NH-LTE network may be a set of NH-LTE access networks that are managed by or have a roaming relationship with an NH-LTE network service provider. An NH-LTE network may be locally owned and operated, for example, by a cable operator or an enterprise, as a hotspot, or in a residence. In one example, an NH-LTE network may be a non-MNO network 124 that allows access by a mobile device 120 to other networks (e.g., wide area network 130 and/or MNO network 122). The non-MNO network 124 may be installed at a specific venue (e.g., a mall, a stadium, or a business) and may provide enhanced coverage or capacity.

In one configuration, the mobile device 120 may need to be authenticated before the mobile device 120 is permitted to use services on the non-MNO network 124. In one example, the mobile device 120 is authenticated based on a device certificate. In another configuration, the mobile device 120 is authenticated based on credential/subscription provided by the user of the mobile device 120. In one example, the mobile device 120 may use the user credentials in addition to, or in place of, the device certificate to authenticate to a network. For example, a non-MNO network 124 operated by an enterprise may require the mobile device 120 to authenticate using user credentials (e.g., username, password, payment information, etc.) as an added security measure.

As shown in FIG. 1, the wireless communication system 100 may include one or more servers 118 to perform or otherwise aide in the authentication and/or subscription provisioning of the mobile device 120. For example, the servers 118 may include an authentication server, such as an authentication, authorization, and accounting (AAA) server. The servers 118 may also include a subscription and policy provisioning server. In one configuration, the mobile device 120 performs connection setup procedures by exchanging messages (e.g., extensible authentication protocol (EAP) messages) with the servers 118 via the small cell base station 110B.

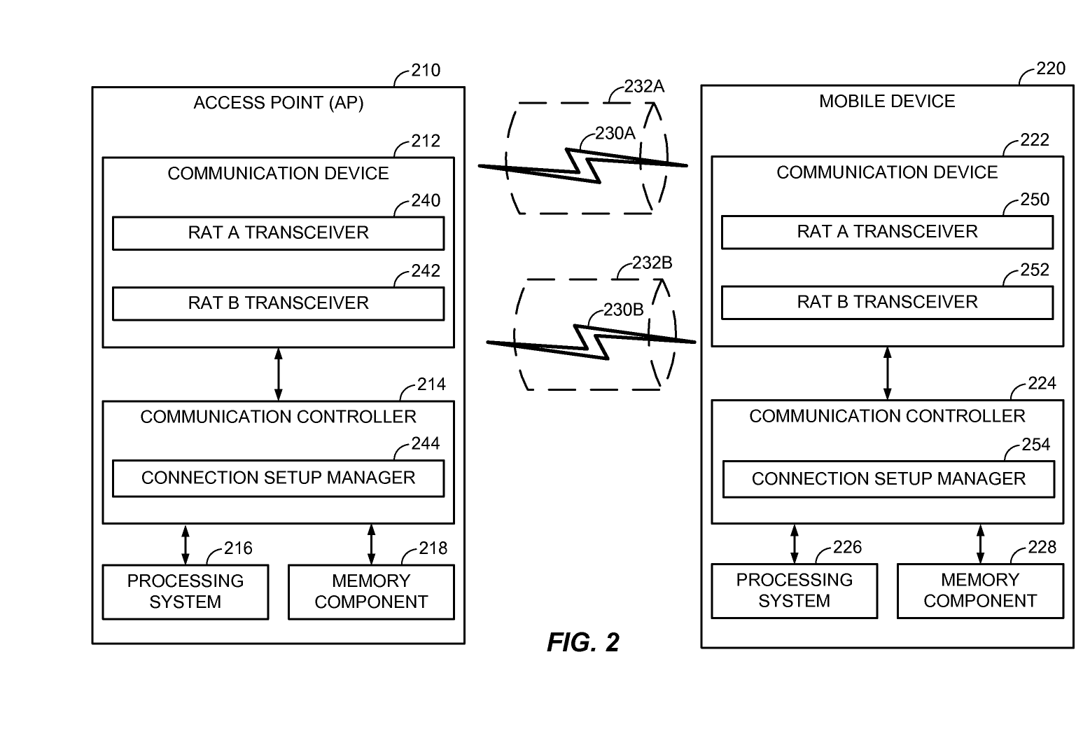

FIG. 2 illustrates an example wireless communication system including an Access Point (AP) 210 in communication with a mobile device 220. The access point 210 is one possible implementation of the small cell base station 110B of FIG. 1, while the mobile device 220 is one possible implementation of the mobile device 120 of FIG. 1. Unless otherwise noted, the terms “mobile device” and “access point” are not intended to be specific or limited to any particular Radio Access Technology (RAT). In general, the mobile device 220 may be any wireless communication device allowing a user to communicate over a communications network (e.g., a mobile phone, router, personal computer, server, entertainment device, Internet of Things (IOT)/Internet of Everything (JOE) capable device, in-vehicle communication device, etc.), and may be alternatively referred to in different RAT environments as a User Device (UD), a Mobile Station (MS), a Subscriber Station (STA), a User Equipment (UE), etc. Similarly, the access point 210 may operate according to one or several RATs in communicating with mobile devices depending on the network in which the access point 210 is deployed, and may be alternatively referred to as a Base Station (BS), a Network Node, a NodeB, an evolved NodeB (eNB), etc. Such an access point may correspond to a small cell access point, for example. “Small cells” generally refer to a class of low-powered access points that may include or be otherwise referred to as femto cells, pico cells, micro cells, Wi-Fi APs, other small coverage area APs, etc. Small cells may be deployed to supplement macro cell coverage, which may cover a few blocks within a neighborhood or several square miles in a rural environment, thereby leading to improved signaling, incremental capacity growth, richer user experience, and so on.

In the example of FIG. 2, the access point 210 and the mobile device 220 each generally include a wireless communication device (represented by the communication devices 212 and 222) for communicating with other network nodes via at least two designated RAT types. The communication devices 212 and 222 may be variously configured for transmitting and encoding signals (e.g., messages, indications, information, and so on), and, conversely, for receiving and decoding signals (e.g., messages, indications, information, pilots, and so on) in accordance with the designated RAT. The access point 210 and the mobile device 220 may also each generally include a communication controller (represented by the communication controllers 214 and 224) for controlling operation of their respective communication devices 212 and 222 (e.g., directing, modifying, enabling, disabling, etc.). The communication controllers 214 and 224 may operate at the direction of or otherwise in conjunction with respective host system functionality (illustrated as the processing systems 216 and 226 and the memory components 218 and 228). Persons skilled in the art will appreciate that memory components 218 and 228 may be fully on-board, partially on-board, or separate from processing systems 216 and 226, respectively. In some designs, the communication controllers 214 and 224 may be partly or wholly subsumed by the respective host system functionality.

Turning to the illustrated communication in more detail, the mobile device 220 may transmit and receive messages via wireless links 230A and 230B with the access point 210, where the messages include information related to various types of communication (e.g., voice, data, multimedia services, associated control signaling, connection setup procedures, etc.). The wireless links 230A and 230B may operate over a communication medium of interest, shown by way of example in FIG. 2 as the mediums 232A and 232B, which may be shared with other communications as well as other RATs. A medium of this type may be composed of one or more frequency, time, and/or space communication resources (e.g., encompassing one or more channels across one or more carriers) associated with communication between one or more transmitter/receiver pairs, such as the access point 210 and the mobile device 220 for the mediums 232A and 232B.

As a particular example, the mediums 232A and 232B may correspond to at least a portion of an unlicensed frequency band shared with other RATs. In general, the access point 210 and the mobile device 220 may operate via the wireless links 230A and 230B according to one or more RATs depending on the network in which they are deployed. These networks may include, for example, different variants of Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and so on. Although different licensed frequency bands have been reserved for such communications (e.g., by a government entity such as the Federal Communications Commission (FCC) in the United States), certain communication networks, in particular those employing small cell access points, have extended operation into unlicensed frequency bands such as the Unlicensed National Information Infrastructure (U-NII) band used by Wireless Local Area Network (WLAN) technologies, most notably IEEE 802.11x WLAN technologies generally referred to as “Wi-Fi.”

In the example of FIG. 2, the communication device 212 of the access point 210 includes two co-located transceivers operating according to respective RAT types, including a “RAT A” transceiver 240 and a “RAT B” transceiver 242. As used herein, a “transceiver” may include a transmitter circuit, a receiver circuit, or a combination thereof, but need not provide both transmit and receive functionalities in all designs. For example, a low functionality receiver circuit may be employed in some designs to reduce costs when providing full communication is not necessary (e.g., a Wi-Fi chip or similar circuitry simply providing low-level sniffing). Further, as used herein, the term “co-located” (e.g., radios, access points, transceivers, etc.) may refer to one of various arrangements. For example, components that are in the same housing; components that are hosted by the same processor; components that are within a defined distance of one another; and/or components that are connected via an interface (e.g., an Ethernet switch) where the interface meets the latency requirements of any required inter-component communication (e.g., messaging).

The RAT A transceiver 240 and the RAT B transceiver 242 may be of different RAT types, may provide different functionalities, and may be used for different purposes. As an example, the RAT A transceiver 240 may be a Long-Term Evolution (LTE) wireless communication transceiver that operates in accordance with Long Term Evolution (LTE) technology to provide communication with the mobile device 220 on the wireless link 230A, while the RAT B transceiver 242 may operate in accordance with Wi-Fi technology to monitor Wi-Fi signaling on the medium 232B. The communication device 222 of the mobile device 220 includes a similar RAT A transceiver 250 of a first RAT type (e.g., LTE) and a RAT B transceiver 252 of a second RAT type (Wi-Fi). In one embodiment, the RAT A transceiver 250 is the only LTE wireless communication transceiver included in the mobile device 220. That is, the mobile device 220 may include no more than a single LTE wireless communication transceiver (e.g., RAT A transceiver 250), but may include additional transceivers of other RAT types (e.g., Wi-Fi).

As mentioned above, the process of network capability discovery and credential/subscription provisioning on NH-LTE Networks takes time as the user of the mobile device 220 may need to provide credentials and/or payment information. For mobile devices with a single LTE radio (e.g., mobile device 220 with a single RAT A transceiver 250), mobile terminated calls may be missed and/or data disrupted during this time if the mobile device 220 is not connected to a macro base station. Accordingly, embodiments discussed herein provide for wireless network connection setup procedures using multiple RAT types. That is, since mobile device 220 may only include one RAT A transceiver 250 of a first RAT type (e.g., LTE wireless communications), the mobile device 220 may thus utilize RAT B transceiver 252 of a second type (e.g., Wi-Fi) to perform or otherwise aide in the network discovery and/or authentication of the mobile device 220 on a non-MNO network. As mentioned above, the RAT B transceiver 252 may include a Wi-Fi transceiver. Thus, the mobile device 220 may perform NH network discovery and/or authentication over Wi-Fi (via RAT B transceiver 252), while remaining connected to a macro base station (via RAT A transceiver 250) for voice service.

In another embodiment, both the RAT A transceiver 250 and the RAT B transceiver 252 are Long-Term Evolution (LTE) wireless communication transceivers, such that the mobile device 220 may perform NH network discovery and/or authentication over LTE (via RAT B transceiver 252), while remaining connected to a macro base station, also over LTE, (via RAT A transceiver 250) for voice service.

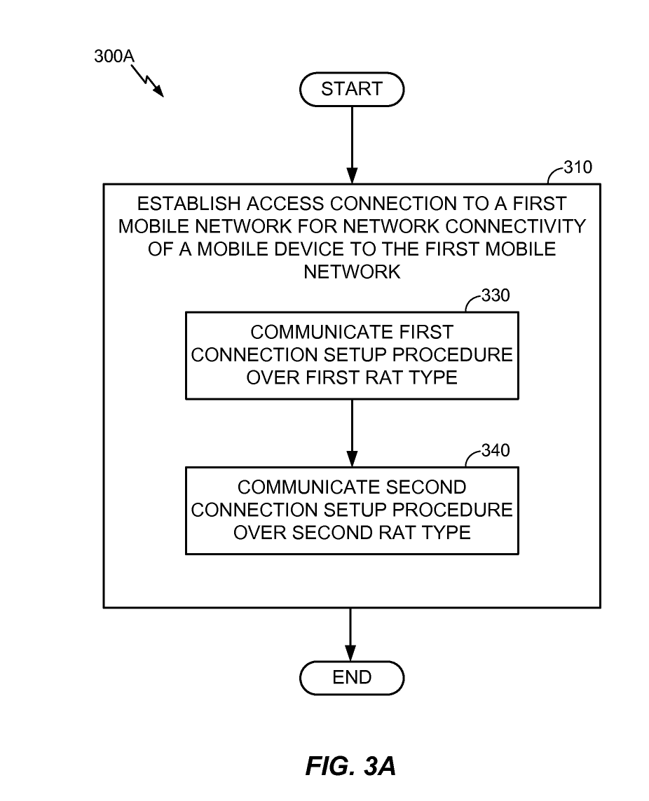

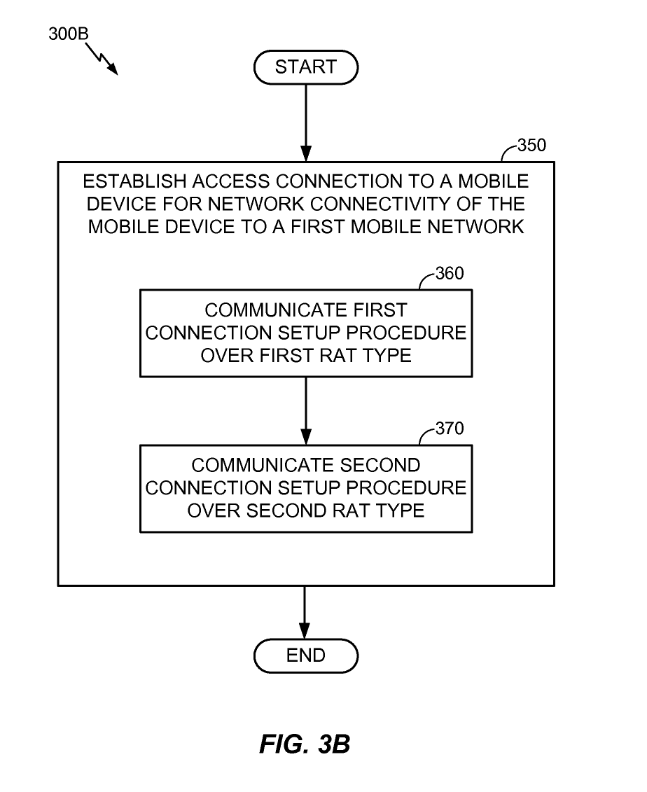

FIG. 3A is a flowchart illustrating a process 300A, performed by a mobile device, of wireless communication that includes establishing an access connection to a first mobile network. The process 300A is one possible process performed by the mobile device 120 of FIG. 1 for establishing an access connection to non-MNO network 124. The process 300A is also one possible process performed by the mobile device 220 of FIG. 2 for establishing an access connection to the access point 210.

In a process block 310, under control of a communication controller, such as connection setup manager 254 of the mobile device 220, the mobile device 200 begins establishing an access connection to a first mobile network (e.g., non-MNO network 124) for network connectivity of the mobile device 220 to the first mobile network. Establishing the access connection includes performing a plurality of connection setup procedures. For example, the connection setup procedures may include network discovery, credential provisioning, policy provisioning, and authentication. In another example, the connection setup procedures include one or more of the following: Access Network Query Protocol (ANQP), OSU, authentication, and data traffic procedures.

As described above, the mobile device 220 includes a first transceiver of a first radio access technology (RAT) type and a second transceiver of a second RAT type. Thus, the process 300A includes process block 330 of communicating at least one of the connection setup procedures with the first transceiver (e.g., RAT A transceiver 250) over the first RAT type, and a process block 340 of communicating at least another one of the connection setup procedures with the second transceiver (e.g., RAT B transceiver 252) over the second RAT type. By way of example, the first RAT type may include LTE wireless communication, while the second RAT type includes Wi-Fi wireless communication. Each of the above-noted connection setup procedures may be performed over LTE or Wi-Fi to establish the access connection, leading to various combinations of communicating the connection setup procedures, as shown below with reference to processes 500-800.

Furthermore, in one example, a connection setup manager, such as the connection setup manager 254 may dynamically determine which of the connection setup procedures will be communicated over LTE, and which, if any will be communicated over Wi-Fi. In one embodiment, this determination is made dependent on whether Wi-Fi is made available in the non-MNO network 124.

In yet another embodiment, where the RAT A transceiver 250 and the RAT B transceiver 252, of the mobile device 220, are both LTE wireless communication transceivers, some of the above-noted connection setup procedures may be performed over LTE via the RAT A transceiver 250, while at least some of the other connection setup procedures for establishing the same access connection are performed over LTE via the RAT B transceiver 252.

FIG. 3B is a flowchart illustrating a process 300B, performed by one or more APs of a first mobile network (e.g., non-MNO network 124) for wireless communication that includes establishing an access connection to a mobile device for network connectivity to the first mobile network (e.g., non-MNO network 124). The process 300B is one possible process performed by the small cell base station 110B of FIG. 1 for establishing an access connection of the mobile device 120 to the non-MNO network 124. The process 300B is also one possible process performed by the access point 210 of FIG. 2 for establishing an access connection between the mobile device 220 and the access point 210.

In a process block 350, under control of a communication controller, such as connection setup manager 244 of the access point 210, the access point 210 establishes an access connection to a mobile device (e.g., mobile device 220) for network connectivity of the mobile device to a first mobile network (e.g., non-MNO network 124). Establishing the access connection to the mobile device may include communicating (e.g., relaying) a plurality of connection setup procedures between the mobile device 220 and one or more MNO servers (e.g., servers 118 of FIG. 1). As described above, the connection setup procedures may include network discovery, Access Network Query Protocol (ANQP), OSU, authentication, and data traffic procedures.

Also, as described above, the access point 210 includes a first transceiver of a first radio access technology (RAT) type (e.g., RAT A transceiver 240) and a second transceiver of a second RAT type (e.g., RAT B transceiver 242). Thus, the process 300B includes process block 360 of communicating at least one of the connection setup procedures with the first transceiver over the first RAT type, and process block 370 of communicating at least another one of the connection setup procedures with the second transceiver over the second RAT type. By way of example, the first RAT type may include LTE wireless communication, while the second RAT type includes Wi-Fi wireless communication. Each of the above-noted connection setup procedures may be performed over LTE or Wi-Fi, leading to various combinations of communicating the connection setup procedures, as shown below with reference to processes 500-800.

It is noted that the above process 300B is described above with reference to access point 210 that includes co-located transceivers, RAT A transceiver 240 and RAT B transceiver 242. However, in another embodiment, an NH LTE network, such as Non-MNO network 124, may include an access point for wireless communication of the first RAT type that is separate and distinct from small cell BS 110B that provides wireless communication of the second RAT type. For example, Non-MNO network 124 may include a dedicated Wi-Fi access point (AP) for Wi-Fi communications in addition to an LTE eNB (e.g., small cell BS 110B) that provides for LTE communications. In this example, an access connection may be established with a mobile device 120 by communicating at least one of the connection setup procedures via the dedicated Wi-Fi AP and at least another of the connection setup procedures via the LTE eNB.

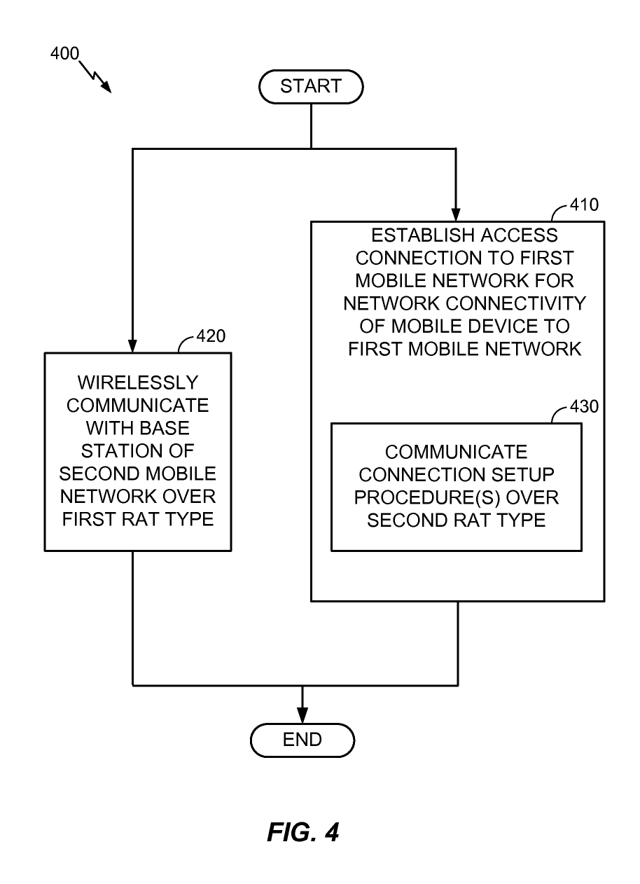

FIG. 4 is a flowchart illustrating a process 400 of communicating connection setup procedures with a first mobile network while simultaneously communicating with a base station of a second mobile network. The process 400 is one possible process performed by the mobile device 120 of FIG. 1 for establishing an access connection to the non-MNO network 124. The process 400 is also one possible process performed by the mobile device 220 of FIG. 2 for establishing an access connection to the access point 210.

In a process block 410, under control of a communication controller, such as the connection setup manager 254 of the mobile device 220, the mobile device 220 begins establishing an access connection to a first mobile network (e.g., non-MNO network 124) for network connectivity of the mobile device 220 to the non-MNO network 124. Establishing the access connection to the non-MNO network 124 includes performing a plurality of connection setup procedures. For example, the connection setup procedures may include network discovery, credential and policy provisioning authentication, and data traffic procedures.

The process 400 also includes a process block 420 of wirelessly communicating with a base station (e.g., macro cell base station 110A) over a first RAT type. In one embodiment, the wireless communication with the base station may include conducting a mobile device-terminated voice call.

However, as described above, not only does the mobile device 220 include a first transceiver of a first radio access technology (RAT) type, but it also includes a second transceiver of a second RAT type. Thus, the process 400 includes establishing the access connection to the mobile network (e.g., non-MNO network 124), as in process block 410, while the mobile device 220 is also wirelessly communicating with the macro cell base station in process block 420. That is, process block 430 includes communicating at least one of the connection setup procedures with the second transceiver over the second RAT type to the access point 210 of the non-MNO network 124 while simultaneously communicating with the macro cell base station 110A (e.g., for the voice call) via the first transceiver. By way of example, the first RAT type may include LTE wireless communication, while the second RAT type includes Wi-Fi wireless communication.

In another embodiment, the connection setup procedures may be communicated using one mobile network (e.g., MNO network 122) while the mobile device 120 is still connected to the macro cell base station 110A of the MNO network 122 in order to establish an access connection with another mobile network. For example, in FIG. 1, the mobile device 120 may communicate connection setup procedures with the macro cell base station 110A in order to establish an access connection to the non-MNO network 124. In this example, the servers 118 should be reachable via the MNO connection. Thus, a method of establishing an access connection of a mobile device to a first mobile network may include wirelessly communicating, by mobile device 120, with a second mobile network (e.g., macro cell base station 110A) for access to the first mobile network (e.g., non-MNO network 124). This wireless communication includes performing, by the mobile device 120, a plurality of connection setup procedures communicated between the mobile device 120 and the macro cell base station 110A. Upon successful completion of the connection setup procedures communicated between the mobile device 120 and the macro cell base station 110A, the mobile device 120 may be granted access to the wide area network 130 and/or MNO network 122 via the non-MNO network 124.

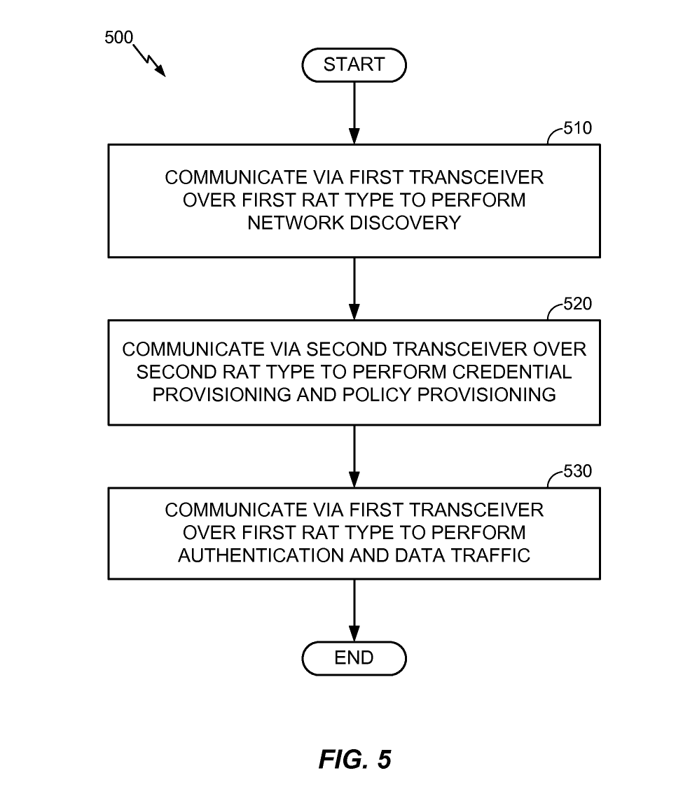

FIG. 5 is a flowchart illustrating a process 500 of wireless communication that includes establishing an access connection of the mobile device 220 to a first mobile network (e.g., non-MNO network 124) where network discovery is performed over a first Radio Access Technology (RAT) type (i.e., process block 510), credential provisioning and policy provisioning procedures are performed over a second RAT type (i.e., process block 520), and authentication and data traffic procedures are performed over the first RAT type (i.e., process block 530). As mentioned above, the first RAT type may include LTE wireless communications, while the second RAT type may include Wi-Fi wireless communications, such that process blocks 510 and 530 are implemented by way of RAT A transceiver 250 and process block 520 is implemented by way of RAT B transceiver 252 of mobile device 220. The process 500 is one possible implementation of the process block 310 of FIG. 3A. The process 500 is also one possible implementation of the process block 350 of FIG. 3B.

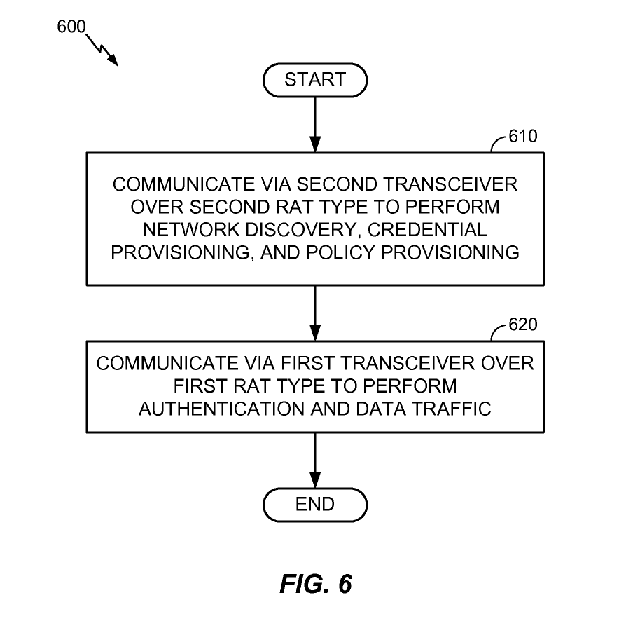

FIG. 6 is a flowchart illustrating a process 600 of wireless communication that includes establishing an access connection of a mobile device (e.g., mobile device 220) to a first mobile network (e.g., non-MNO network 124) where network discovery, credential provisioning and policy provisioning are performed over a first Radio Access Technology (RAT) type (i.e., process block 610), and authentication and data traffic procedures are performed over a second RAT type (i.e., process block 620). As mentioned above, the first RAT type may include LTE wireless communications, while the second RAT type may include Wi-Fi wireless communications, such that process blocks 610 is implemented by way of RAT B transceiver 252 and process block 620 is implemented by way of RAT A transceiver 250 of mobile device 220. The process 600 is one possible implementation of the process block 310 of FIG. 3A. The process 600 is also one possible implementation of the process block 350 of FIG. 3B.

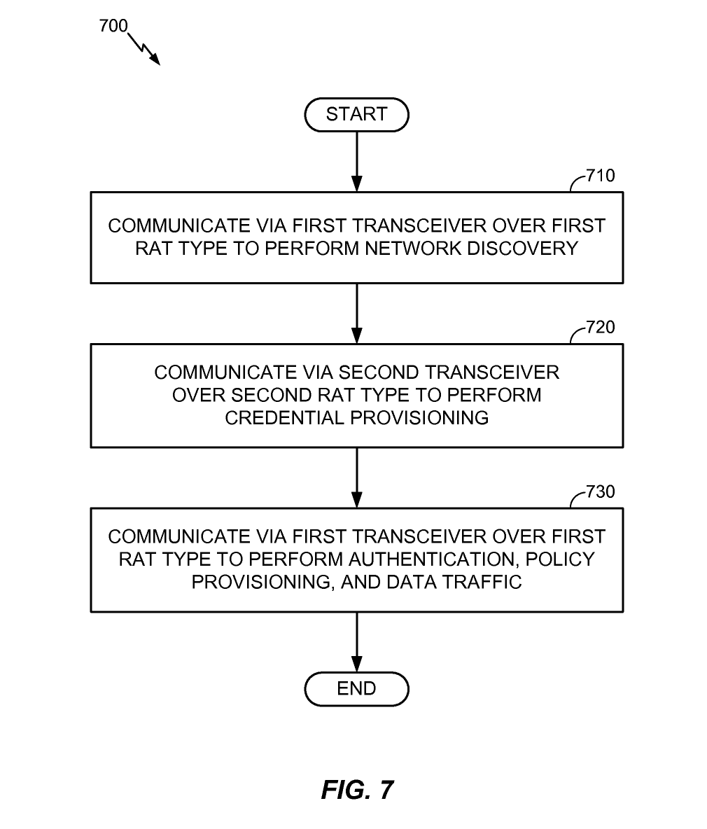

FIG. 7 is a flowchart illustrating a process 700 of wireless communication that includes establishing an access connection of the mobile device 220 to the first mobile network (e.g., non-MNO network 124) where network discovery is performed over a first Radio Access Technology (RAT) type (i.e., process block 710), credential provisioning procedures are performed over a second RAT type (i.e., process block 720), and authentication, policy provisioning and data traffic procedures are performed over the first RAT type (i.e., process block 730). As mentioned above, the first RAT type may include LTE wireless communications, while the second RAT type may include Wi-Fi wireless communications, such that process blocks 710 and 730 are implemented by way of RAT A transceiver 250 and process block 720 is implemented by way of RAT B transceiver 252 of mobile device 220. The process 700 is one possible implementation of the process block 310 of FIG. 3A. The process 700 is also one possible implementation of the process block 350 of FIG. 3B.

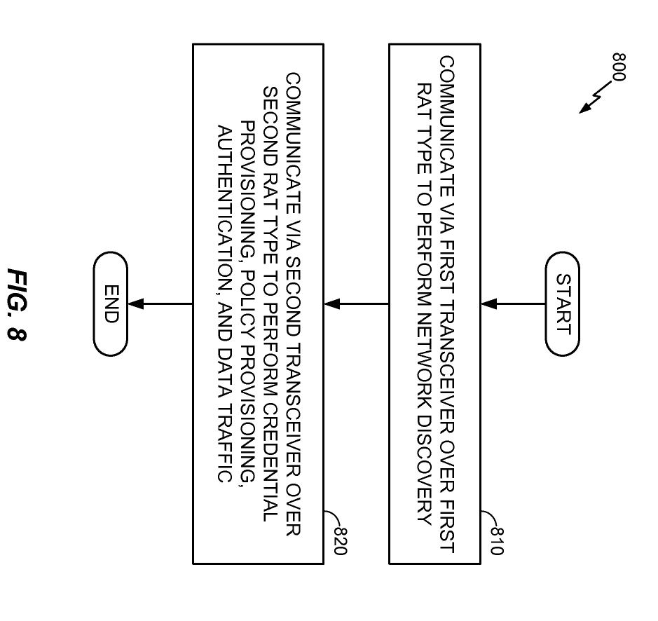

FIG. 8 is a flowchart illustrating a process 800 of wireless communication that includes establishing an access connection of a mobile device (e.g., mobile device 220) to a first mobile network (e.g., non-MNO network 124) where network discovery is performed over a first Radio Access Technology (RAT) type (i.e., process block 810), and credential provisioning, policy provisioning, authentication and data traffic procedures are performed over a second RAT type (i.e., process block 820). As mentioned above, the first RAT type may include LTE wireless communications, while the second RAT type may include Wi-Fi wireless communications, such that process block 810 is implemented by way of RAT A transceiver 250 and process block 820 is implemented by way of RAT B transceiver 252 of mobile device 220. The process 800 is one possible implementation of the process block 310 of FIG. 3A. The process 800 is also one possible implementation of the process block 350 of FIG. 3B.

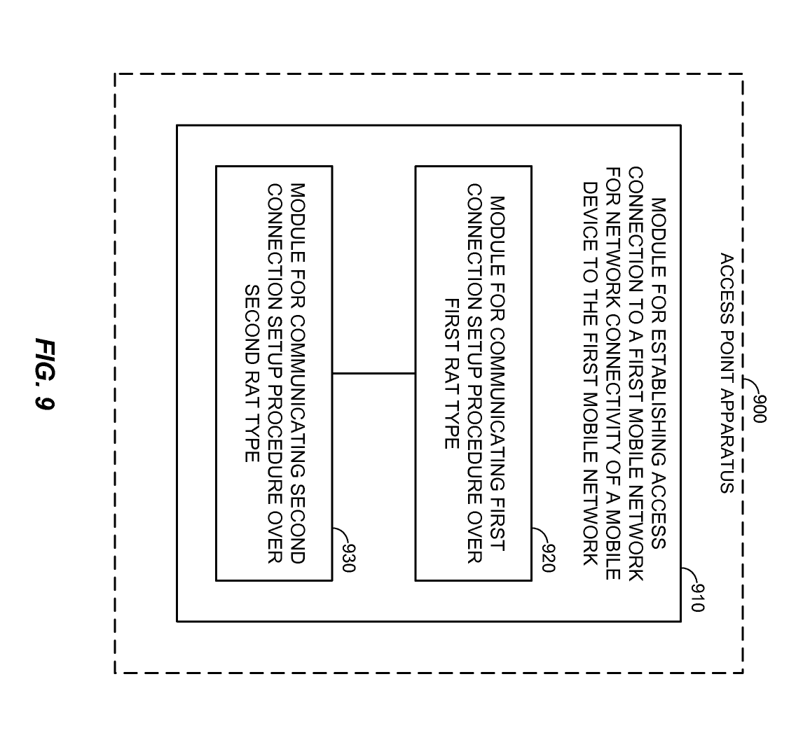

FIG. 9 is a simplified block diagram illustrating several sample aspects of components that may be employed in an access point apparatus 900 configured to support communication as taught herein. The access point apparatus 900 is one possible implementation of base station 110 of FIG. 1 and/or access point 210 of FIG. 2, represented as a series of interrelated functional modules.

A module 910 for wireless communicating with a mobile device to perform connection setup procedures may correspond at least in some aspects to, for example, a communication controller including a connection setup manager, such as the connection setup manager 244 of FIG. 2. A module 920 for communicating first connection setup procedures over a first RAT type may correspond at least in some aspects to, for example, a communication device or a component thereof as discussed herein (e.g., the RAT A transceiver 240 or the like). A module 930 for communicating second connection setup procedures over a second RAT type may correspond at least in some aspects to, for example, a communication device or a component thereof as discussed herein (e.g., the RAT B transceiver 242 or the like).

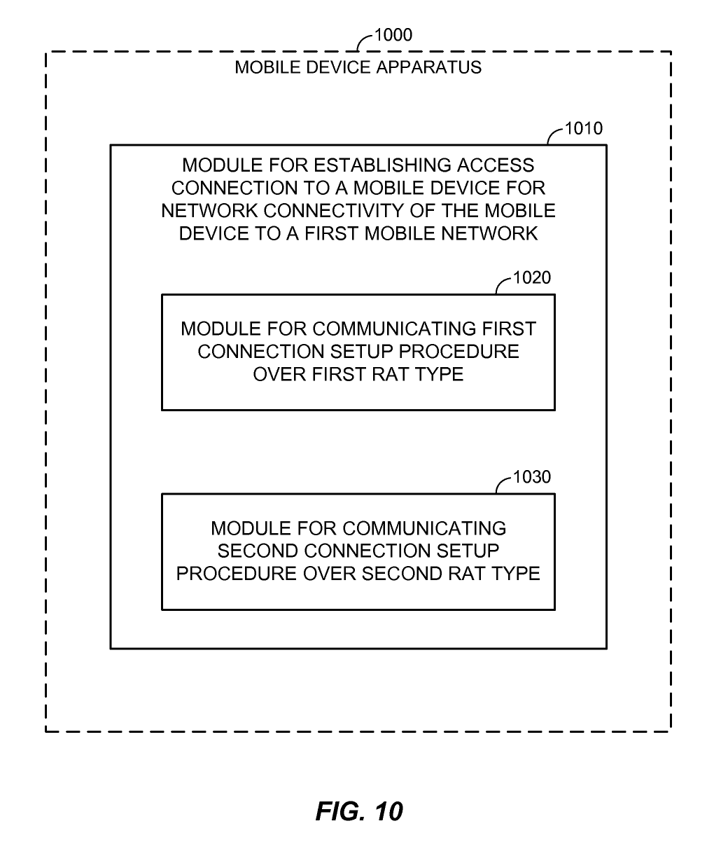

FIG. 10 is a simplified block diagram illustrating several sample aspects of components that may be employed in a mobile device apparatus 1000 configured to support communication as taught herein. The mobile device apparatus 1000 is one possible implementation of the mobile device 120 of FIG. 1 and/or the mobile device 220 of FIG. 2, represented as a series of interrelated functional modules.

A module 1010 for wireless communicating with an access point of a non-MNO network to perform connection setup procedures may correspond at least in some aspects to, for example, a communication controller including a connection setup manager, such as the connection setup manager 254 of FIG. 2. A module 1020 for communicating first connection setup procedures over a first RAT type may correspond at least in some aspects to, for example, a communication device or a component thereof as discussed herein (e.g., the RAT A transceiver 250 or the like). A module 1030 for communicating second connection setup procedures over a second RAT type may correspond at least in some aspects to, for example, a communication device or a component thereof as discussed herein (e.g., the RAT B transceiver 252 or the like).

The functionality of the modules 910-1030 of FIGS. 9 and 10 may be implemented in various ways consistent with the teachings herein. In some designs, the functionality of these modules 910-1030 may be implemented as one or more electrical components. In some designs, the functionality of these modules 910-1030 may be implemented as a processing system including one or more processor components. In some designs, the functionality of these modules 910-1030 may be implemented using, for example, at least a portion of one or more integrated circuits (e.g., an ASIC). As discussed herein, an integrated circuit may include a processor, software, other related components, or some combination thereof Thus, the functionality of different modules may be implemented, for example, as different subsets of an integrated circuit, as different subsets of a set of software modules, or a combination thereof. Also, it will be appreciated that a given subset (e.g., of an integrated circuit and/or of a set of software modules) may provide at least a portion of the functionality for more than one module.

In addition, the components and functions represented by FIGS. 9 and 10, as well as other components and functions described herein, may be implemented using any suitable means. Such means also may be implemented, at least in part, using corresponding structure as taught herein. For example, the components described above in conjunction with the “module for” components of FIGS. 9 and 10 also may correspond to similarly designated “means for” functionality. Thus, in some aspects, one or more of such means may be implemented using one or more of processor components, integrated circuits, or other suitable structure as taught herein.

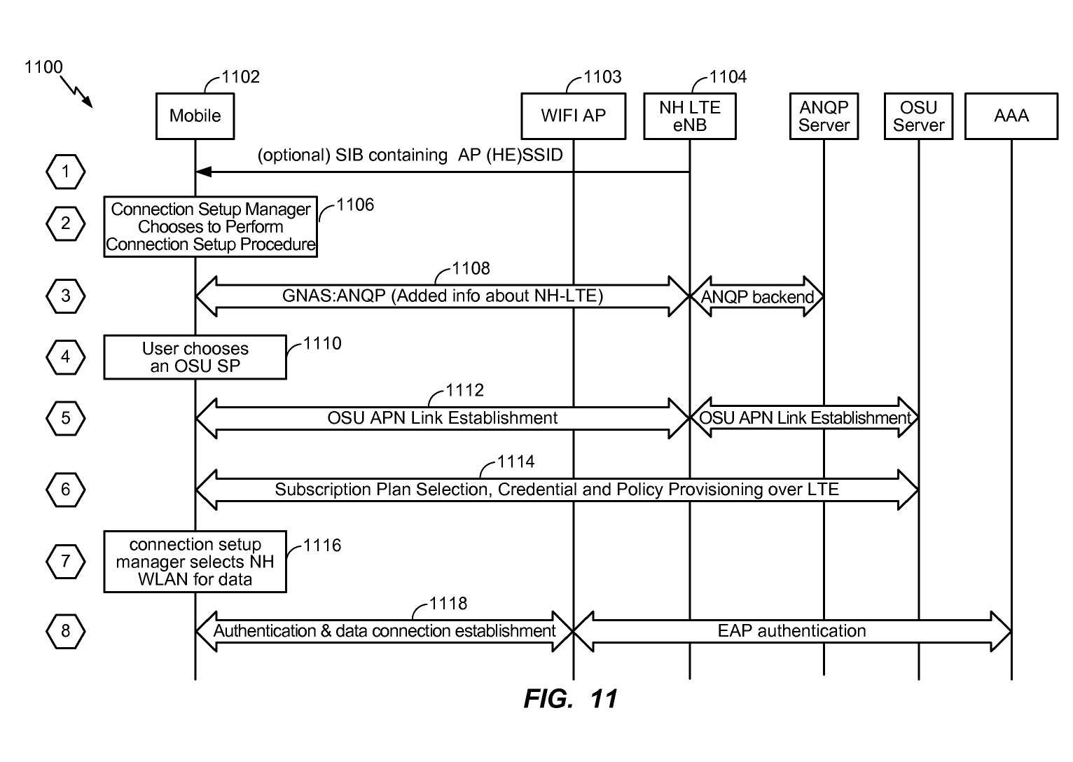

FIG. 11 is an example call flow procedure 1100 to establish connection of a mobile device 1102 to Neutral Host (NH) eNB 1104 of a mobile network. The mobile device 1102 is one possible implementation of the mobile device 120 of FIG. 1 and/or the mobile device 220 of FIG. 2, whereas the NH eNB 1104 is one possible implementation of the access point 210 of FIG. 2. As shown in block 1106, the connection setup manager 113 of the mobile device 1102 chooses to perform a connection setup procedure, such as ANQP over LTE. Thus, the mobile device 1102 exchanges one or more messages 1108 with the NH eNB 1104, communicated with respective LTE wireless communications transceivers (e.g., RAT A transceiver 250 of mobile device 220 and RAT A transceiver 240 of access point 210). Next, a user of the mobile device 1102 chooses to perform online sign-up (OSU) 1110 for access to the NH eNB 1104. In one example, performing OSU includes the mobile device 1102 receiving user input representative of one or more of a username, password, a plan selection, and payment information. Thus, the mobile device 1102 exchanges one or more messages 1112 and 1114 with the NH eNB 1104, communicated with respective LTE wireless communications transceivers (e.g., RAT A transceiver 250 of mobile device 220 and RAT A transceiver 240 of access point 210). Next, connection setup manager 113 of the mobile device 1102 selects WLAN (e.g., Wi-Fi) 1116 for performing another connection setup procedure, such as authentication and for data connection establishment. Thus, the mobile device 1102 exchanges one or more messages 1118 with a wi-fi AP 1103, communicated with respective Wi-Fi wireless communications transceivers (e.g., RAT B transceiver 252 of mobile device 220 and RAT B transceiver 242 of access point 210). In one embodiment, the wi-fi AP 1103 is an additional AP included in the same NHN (e.g., non-MNO network 124) as, and communicatively coupled to, the NH eNB 1104.

Although FIG. 11 illustrates the NH eNB 1104 and the wi-fi AP 1103 as separate entities within the NHN, in another example, the NH eNB 1104 and the wi-fi AP 1103 may be combined into a single access point, such as the access point 210, where communications with the NH eNB 1104 are facilitated by way of RAT A transceiver 240 and communications with wi-fi AP 1103 are facilitated by way of RAT B transceiver 242.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

In view of the descriptions and explanations above, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Accordingly, it will be appreciated, for example, that an apparatus or any component of an apparatus may be configured to (or made operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

Moreover, the methods, sequences, and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary non-transitory storage medium is coupled to the processor such that the processor can read information from, and write information to, the storage medium. In the alternative, the storage medium may be integral to the processor (e.g., cache memory).

Accordingly, it will also be appreciated, that certain aspects of the disclosure can include a non-transitory computer-readable medium embodying a method for establishing a connection of a mobile device to a first mobile network, such as described above with reference to processes 300A, 300B, 400, 500, 600, 700, and 800.

While the foregoing disclosure shows various illustrative aspects, it should be noted that various changes and modifications may be made to the illustrated examples without departing from the scope defined by the appended claims. The present disclosure is not intended to be limited to the specifically illustrated examples alone. For example, unless otherwise noted, the functions, steps, and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of wireless communication, the method comprising:
establishing, by a mobile device, an access connection to a first mobile network for network connectivity of the mobile device to the first mobile network, wherein the mobile device comprises a first transceiver of a first radio access technology (RAT) type and a second transceiver of a second RAT type, and wherein establishing the access connection comprises performing a plurality of connection setup procedures, wherein at least one of the connection setup procedures is communicated with the first transceiver over the first RAT type and at least another one of the connection setup procedures is communicated with the second transceiver over the second RAT type.

2. The method of claim 1, wherein the first mobile network comprises a Neutral Host Long-Term Evolution (NH-LTE) network.

3. The method of claim 1, wherein the first RAT type is Long-Term Evolution (LTE) wireless communication and wherein the second RAT type is Wi-Fi wireless communication.

4. The method of claim 1, further comprising communicating, via the first transceiver of the mobile device, with a base station of a second mobile network, while simultaneously communicating one or more of the connection setup procedures, via the second transceiver of the mobile device, with the first mobile network.

5. The method of claim 1, wherein the plurality of connection setup procedures includes at least two connection setup procedures selected from the group consisting of: network discovery, credential provisioning, policy provisioning, and authentication.

6. The method of claim 1, wherein performing, by the mobile device, the plurality of connection setup procedures to establish the access connection includes performing credential provisioning of a user of the mobile device based on input received at the mobile device from the user.

7. The method of claim 6, wherein the input received at the mobile device from the user includes at least one of a username, password, and payment information.

8. The method of claim 1, wherein performing the plurality of connection setup procedures includes:
communicating via the first transceiver of the mobile device over the first RAT type to perform network discovery;
communicating via the second transceiver of the mobile device over the second RAT type to perform credential provisioning and policy provisioning; and
communicating via the first transceiver of the mobile device over the first RAT type to perform authentication and data traffic.

9. The method of claim 1, wherein performing the plurality of connection setup procedures includes:
communicating via the second transceiver of the mobile device over the second RAT type to perform network discovery, credential provisioning and policy provisioning; and
communicating via the first transceiver of the mobile device over the first RAT type to perform authentication and data traffic.

10. The method of claim 1, wherein performing the plurality of connection setup procedures includes:
communicating via the first transceiver of the mobile device over the first RAT type to perform network discovery;
communicating via the second transceiver of the mobile device over the second RAT type to perform credential provisioning; and
communicating via the first transceiver of the mobile device over the first RAT type to perform authentication, policy provisioning and data traffic.

11. The method of claim 1, wherein performing the plurality of connection setup procedures includes:
communicating via the first transceiver of the mobile device over the first RAT type to perform network discovery; and
communicating via the second transceiver of the mobile device over the second RAT type to perform credential and policy provisioning, authentication and data traffic.

12. A method of wireless communication, the method comprising:
establishing, by one or more access points of a first mobile network, an access connection to a mobile device for network connectivity of the mobile device to the first mobile network, wherein the one or more access points of the first mobile network comprise a first transceiver of a first radio access technology (RAT) type and a second transceiver of a second RAT type, and wherein establishing the access connection comprises performing a plurality of connection setup procedures, wherein at least one of the connection setup procedures is communicated with the first transceiver over the first RAT type and at least another one of the connection setup procedures is communicated with the second transceiver over the second RAT type.

13. The method of claim 12, wherein the first mobile network comprises a Neutral Host Long-Term Evolution (NH-LTE) network.

14. The method of claim 12, wherein the first RAT type is Long-Term Evolution (LTE) wireless communication and wherein the second RAT type is Wi-Fi wireless communication.

15. The method of claim 12, wherein the plurality of connection setup procedures includes at least two connection setup procedures selected from the group consisting of: network discovery, credential provisioning, policy provisioning, and authentication.

16. The method of claim 12, wherein performing the plurality of connection setup procedures includes:
communicating via the first transceiver of the first mobile network over the first RAT type to perform network discovery;
communicating via the second transceiver of the first mobile network over the second RAT type to perform credential and policy provisioning; and
communicating via the first transceiver of the first mobile network over the first RAT type to perform authentication and data traffic.

17. The method of claim 12, wherein performing the plurality of connection setup procedures includes:
communicating via the second transceiver of the first mobile network over the second RAT type to perform network discovery, credential provisioning and policy provisioning; and
communicating via the first transceiver of the first mobile network over the first RAT type to perform authentication and data traffic.

18. The method of claim 12, wherein performing the plurality of connection setup procedures includes:
communicating via the first transceiver of the first mobile network over the first RAT type to perform network discovery;
communicating via the second transceiver of the first mobile network over the second RAT type to perform credential provisioning; and
communicating via the first transceiver of the first mobile network over the first RAT type to perform authentication, policy provisioning and data traffic.

19. The method of claim 12, wherein performing the plurality of connection setup procedures includes:
communicating via the first transceiver of the first mobile network over the first RAT type to perform network discovery; and
communicating via the second transceiver of the first mobile network over the second RAT type to perform credential and policy provisioning, authentication and data traffic.

20. A mobile device, comprising:
a first transceiver of a first radio access technology (RAT) type;
a second transceiver of a second RAT type;
memory adapted to store program code; and
a processing unit coupled to the memory to access and execute instructions included in the program code to direct the mobile device to:
establish an access connection to a first mobile network for network connectivity of the mobile device to the first mobile network, wherein the instructions to establish the access connection comprise instructions to perform a plurality of connection setup procedures, wherein at least one of the connection setup procedures is communicated with the first transceiver over the first RAT type and at least another one of the connection setup procedures is communicated with the second transceiver over the second RAT type.

21. The mobile device of claim 20, wherein the first mobile network comprises a Neutral Host Long-Term Evolution (NH-LTE) network.

22. The mobile device of claim 20, wherein the first RAT type is Long-Term Evolution (LTE) wireless communication and wherein the second RAT type is Wi-Fi wireless communication.

23. The mobile device of claim 20, further comprising instructions to communicate, via the first transceiver of the mobile device, with a base station of a second mobile network, while simultaneously communicating one or more of the connection setup procedures, via the second transceiver of the mobile device, with the first mobile network.

24. The mobile device of claim 20, wherein the plurality of connection setup procedures includes at least two connection setup procedures selected from the group consisting of: network discovery, credential provisioning, policy provisioning, and authentication.

25. The mobile device of claim 20, wherein the instructions to perform, by the mobile device, the plurality of connection setup procedures to establish the access connection includes instructions to perform credential provisioning of a user of the mobile device based on input received at the mobile device from the user.

26. The mobile device of claim 25, wherein the input received at the mobile device from the user includes at least one of a username, password, and payment information.

27. An access point, comprising:
a first transceiver of a first radio access technology (RAT) type;
a second transceiver of a second RAT type;
memory adapted to store program code; and
a processing unit coupled to the memory to access and execute instructions included in the program code to direct the access point to:
establish an access connection to a mobile device for network connectivity of the mobile device to a first mobile network by the access point, wherein the instructions to establish the access connection comprises instructions to perform a plurality of connection setup procedures, wherein at least one of the connection setup procedures is communicated with the first transceiver over the first RAT type and at least another one of the connection setup procedures is communicated with the second transceiver over the second RAT type.

28. The access point of claim 27, wherein the first mobile network comprises a Neutral Host Long-Term Evolution (NH-LTE) network.

29. The access point of claim 27, wherein the first RAT type is Long-Term Evolution (LTE) wireless communication and wherein the second RAT type is Wi-Fi wireless communication.

30. The access point of claim 27, wherein the plurality of connection setup procedures includes at least two connection setup procedures selected from the group consisting of: network discovery, credential provisioning, policy provisioning, and authentication.
